(19) United States
(12) Patent Application Publication
(10) Pub. No.: US 2013/0142930 A1
(43) Pub. Date: Jun. 6, 2013

(54) CONTAINER FOR SINGLE-SERVE LIQUID/SOLID FOOD PRODUCT

(71) Applicant: Michael David Rabin, New York, NY (US)

(72) Inventor: Michael David Rabin, New York, NY (US)

(21) Appl. No.: 13/757,975

(22) Filed: Feb. 4, 2013

Related U.S. Application Data
(62) Division of application No. 12/753,505, filed on Apr. 2, 2010.

(51) Int. Cl. A23L 1/39; B65B 29/00

(52) U.S. Cl. CPC A23L 1/39; B65B 29/00
USPC 426/431; 53/471

(57) ABSTRACT

A container that enables a food product with one or more pieces of solid food, such as soup, to be made utilizing a brewing machine. The container can be configured to hermetically contain a soup extract and dried pieces of solid food. The container can be pierceable to accommodate an injection of water into the container for combination with the soup extract to produce a broth, and an outflow of the broth from the bottom of the container. The container can also contain one or more inner chambers holding solid food pieces in an isolated location that can be kept separate and dry from both the water that flows into the container as well from the broth that is produced when the soup extract is infused with the water.

### FIELD OF THE DISCLOSURE

This relates to containers for food products for use in single-serve brewing machines, including food products comprising both liquid and solid food.

### BACKGROUND

Single-serve brewing machines produce one cup of coffee, tea, or hot chocolate at a time using a single-serve cartridge. An example of a single-serve brewing machine is the brewing system manufactured by Keurig, Inc., which uses single-serve K-Cup® cartridges that are also manufactured by Keurig, Inc. The single-serve cartridge is a small plastic cup designed for placement within the single-serve brewing machine, and contains several elements including a foil lid, a plastic outer shell, and usually a filter. For instance, a single-serve cartridge that brews coffee or tea has a filter to hold the coffee grinds or tea leaves in place. In contrast, a single-serve cartridge that brews hot chocolate typically does not contain a filter.

To use a single-serve cartridge, a user places the cartridge within a single-serve brewing machine, closes the lid of the machine and presses a brew button. The machine contains an inlet needle and an outlet needle, which penetrate the top and bottom, respectively, of the cartridge. The machine injects heated water through the inlet needle into the cartridge, and drains the brewed beverage from the bottom of the cartridge through the outlet needle into the user's cup. Once the beverage has been brewed, the cartridge is removed from the machine and discarded.

### SUMMARY

A container is disclosed that enables a food product with one or more pieces of solid food, such as soup, to be made utilizing a needle-based brewing machine. For example, the container can be configured to hermetically contain a soup extract and dried pieces of solid food. The container can be pierceable to accommodate an injection of water into the container for combination with the soup extract to produce a broth, and an outflow of the broth from the bottom of the container. The container can also contain one or more inner chambers holding solid food pieces in an isolated location that can be kept separate and dry from both the water that flows into the container as well from the broth that is produced when the soup extract is infused with the water.

The container can also be configured with a peelable lid to allow a user to peel back the lid and pour the solid contents, which are contained in the separate chamber or “cup-within-a-cup” into the user's brewed broth. To create a cup of soup, for example, the user can place the container into the brewing machine and press the brew button. The lid and the bottom of the container can be pierced by the brewing machine's needles. Heated water can flow through the container and mix with the soup extract forming a broth, which can exit the container into the user's cup through the outflow needle of the brewing machine. When the water flow is complete, the user can remove the container from the brewing machine and, rather than discarding the container, open the container utilizing the peelable lid. The solid food contents of the container can then be poured into the user's cup of broth. In other embodiments, the one or more inner chambers can contain small perforations that enable the heating of the solid food contained within those chambers by the heated water during the brewing process.

### BRIEF DESCRIPTION OF THE DRAWINGS

FIG. 1 illustrates an example of a lid portion of a container according to the present disclosure.

FIG. 2 illustrates an example of a base portion of a container with a substantially cylindrical holding chamber according to the present disclosure.

FIG. 3 illustrates an example of a perspective view of a container according to the present disclosure.

FIG. 4 illustrates an example of a base portion of a container with a substantially conical holding chamber according to the present disclosure.

FIG. 5 illustrates an example of a base portion of a container with multiple holding chambers according to the present disclosure.

FIG. 6 illustrates an example of a base portion of a container with a perimeter-encircling holding chamber according to the present disclosure.

FIG. 7 illustrates an example of a base portion of a container with a perforated holding chamber and infusion chamber pierced by inlet and outlet needles according to the present disclosure.

FIG. 8 illustrates an example of process for making a container according to the present disclosure.

FIG. 9 illustrates an example of process for using a container according to the present disclosure.

### DETAILED DESCRIPTION

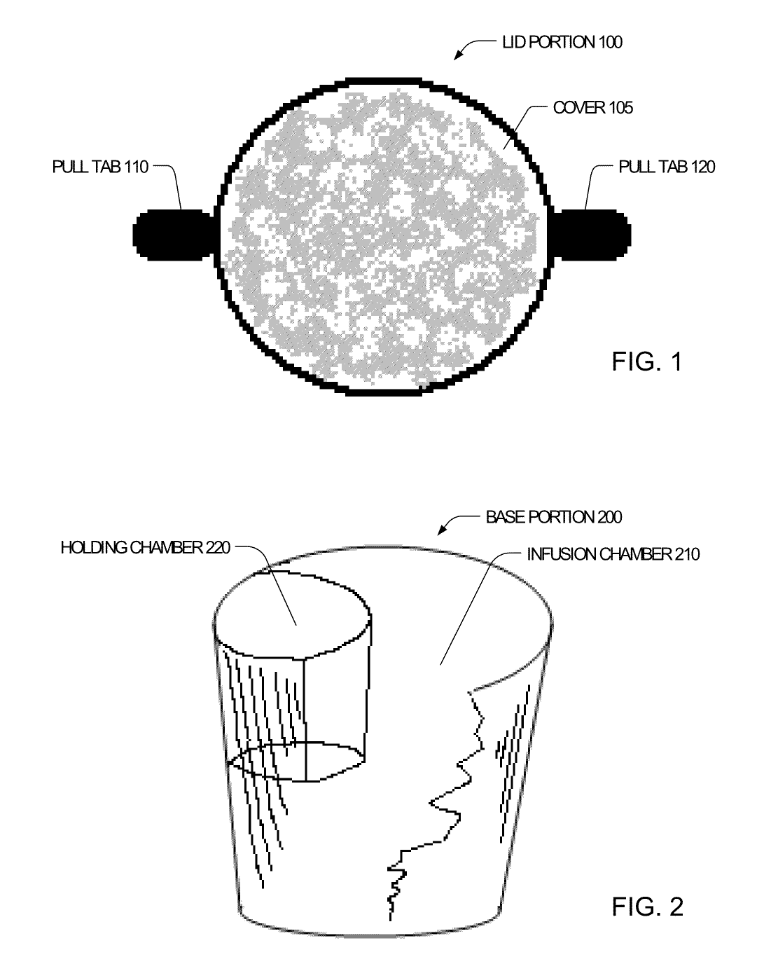

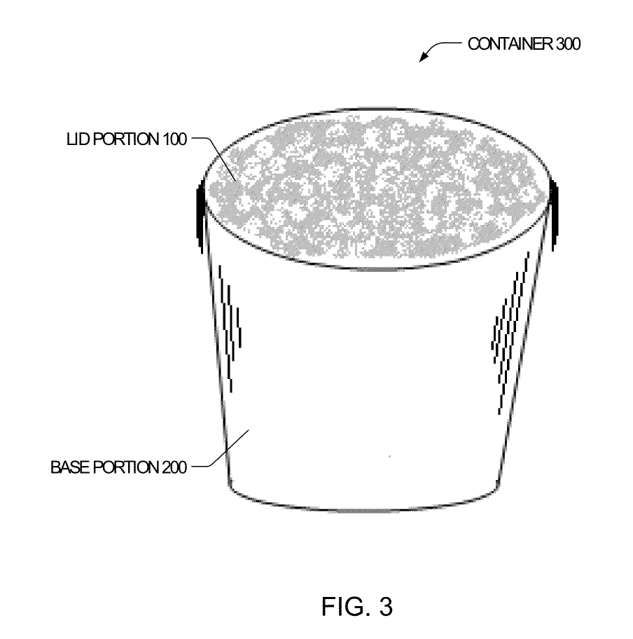

A container according to an embodiment of the present disclosure comprises a base portion and a lid portion removably attached to the base portion. An example of a lid potion of the container, lid portion 100, is shown in FIG. 1. Examples of a base portion of the container, base portions 200, 300, 400, 500, 600 and 700, are shown in FIG. 2-7. An example of the container, container 300, with lid portion 100 attached to base portion 200, is shown in FIG. 3.

In the embodiment shown in FIG. 1, lid portion 100 of the container comprises cover 105 with pull tabs 110 and 120 attached thereto. Pull tabs 110 and 120 can be configured to allow a user to pull on one of the pull tabs to peel back cover 105 from a base portion of the container to which cover 105 is attached. Pull tabs 110 and 120 are shaped in a thin and narrow manner, but can take any suitable shape to simplify handling, such as a wider shape for example. Pull tabs 110 and 120 are arranged on opposite sides of cover 105, but can be arranged in any suitable location around the perimeter of cover 105 to simplify handling. Further, although lid portion 100 is shown to have two pull tabs in FIG. 1, lid portion 100 can have only one pull tab or more than two pull tabs in other embodiments.

Cover 105 can be made of foil, plastic or other suitable pierceable and peelable material. The one or more pull tabs attached to cover 105 can be made of the same material as cover 105 or a different material. For example, the one or more pull tabs can be made from a heat resistant material. The oppositely arranged heat resistant pull tabs can allow a user to safely remove a hot container from a brewing machine with two fingers. The one or more pull tabs can also be used to peel back cover 105 from a base portion of the container.

In the embodiment shown in FIG. 2, base portion 200 of the container comprises infusion chamber 210 and holding chamber 220. Holding chamber 220 contains solid food pieces (not shown). Infusion chamber 210 contains a water soluble food extract. The water soluble food extract produces a liquid food when infused with a heated liquid, such as hot water provided by a brewing machine through infusion chamber 210 for example.

In the embodiment shown in FIG. 3, lid portion 100 is attached to base portion 200. Lid portion 100 can be attached to base portion 200 with any suitable adhesive that provides an adequate seal for infusion chamber 210 and holding chamber 220, and allows a user to pull on one of the pull tabs to peel back cover 105 from base portion 200. The one or more pull tabs attached to lid portion 100 can also be bent downward in proximity to base portion 200 for safe handling by a user when container 300 is hot due to a brewing process.

The food product provided in the container can be any food product that combines both liquid and solid food. For example, in one embodiment, the food product can comprise a soup that combines solid food, such as meat pieces, with liquid food, such as a broth of the soup. For a soup food product, for example, the container can provide the non-water soluble solid food pieces in a dried form in holding chamber 220, and a water soluble broth extract in infusion chamber 210. In another embodiment, the food product can comprise a beverage that combines solid food, such a miniature marshmallows, with liquid food, such as hot chocolate. For a beverage food product, for example, the container can provide the solid food pieces in holding chamber 220, and a water soluble beverage extract in infusion chamber 210.

Examples of soup food products that can be provided in a container in accordance with the embodiments of the present disclosure can include chicken broth with mushrooms and scallions, beef broth with mushrooms and scallions, miso soup with tofu and scallions, chicken and noodle soup, beef and noodle soup, mixed vegetable soup with chicken broth, mixed vegetable soup with beef broth, vegetable soup with vegetable broth, shrimp flavored broth and noodles, thai shrimp soup, onion soup, leek and potato soup, coconut milk and shrimp soup, chicken dumplings soup, beef dumpling soup, pork dumpling soup, etc.

Infusion chamber 210 provides a channel between lid portion 100, when attached to base portion 200, and a bottom of base portion 200. The channel can provide a pathway for heated liquid injected into infusion chamber 210 by an inlet needle of a brewing machine penetrating the attached lid portion 100 and drained from the bottom of base portion 200 by an outlet needle of the brewing machine penetrating the bottom of base portion 200. Infusion chamber 210 is located centrally in base portion 200 to accommodate penetration of an inlet needle and an outlet needle of a brewing machine into infusion chamber 210 at a central location at the top and bottom of the container. Holding chamber 220 is therefore located peripherally in base portion 200 to prevent penetration of an inlet needle or an outlet needle of a brewing machine into holding chamber 220.

In other embodiments, infusion chamber 210 and holding chamber 220 can be located in other arrangements relative to one another in order to accommodate a different placement of inlet and outlet needles in the manner indicated above. For example, to accommodate a brewing machine that penetrates a container at a peripheral location at the top and bottom of the container, for example, infusion chamber 210 can be peripherally located and holding chamber 220 can be centrally located in base portion 200.

Holding chamber 220 has a top opening that can either be sealed by the attached lid portion 100 or be disposed in close enough proximity to the attached lid portion 100 to prevent the solid food pieces contained therein from exiting into infusion chamber 210 due to handling of the container. Holding chamber 220 extends downward from the attached lid portion 100 and has a substantially cylindrical shape. Holding chamber 220 extends downward only partially toward the bottom of base portion 200 (i.e., the bottom of holding chamber 220 is raised from the bottom of base portion 200), but can extend fully to the bottom of base portion 200 in other embodiments.

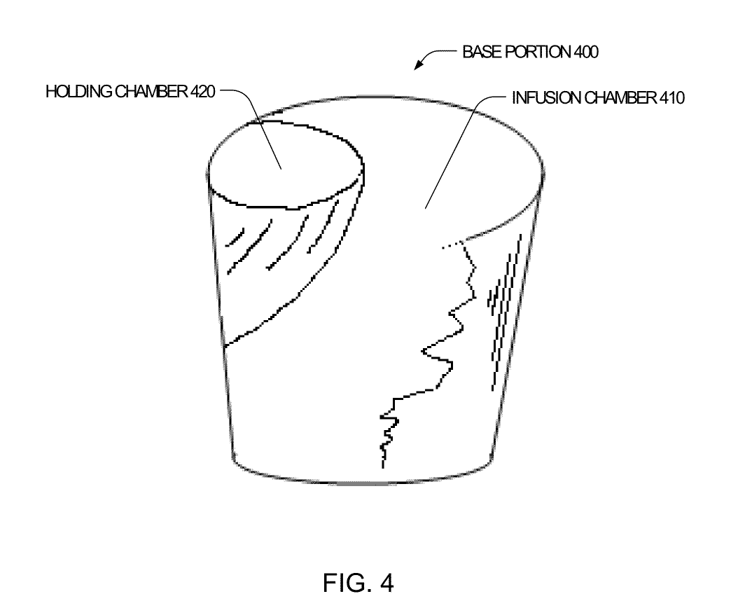

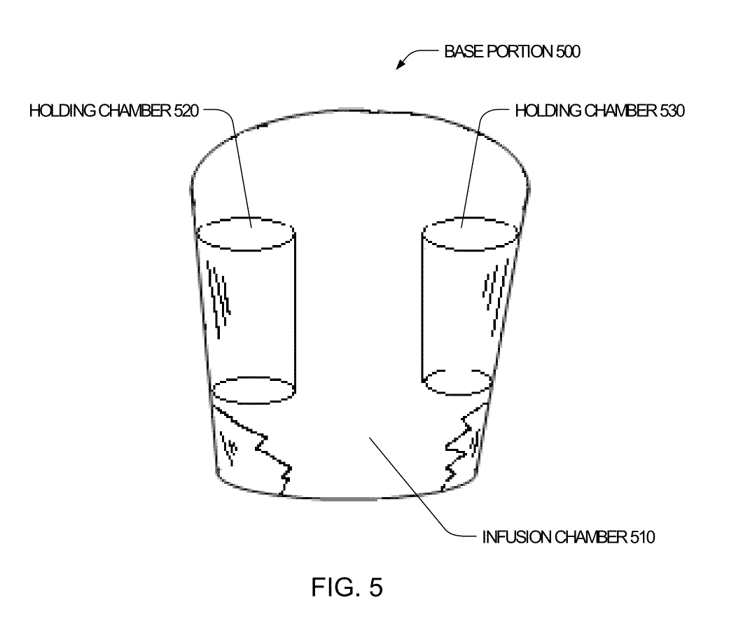

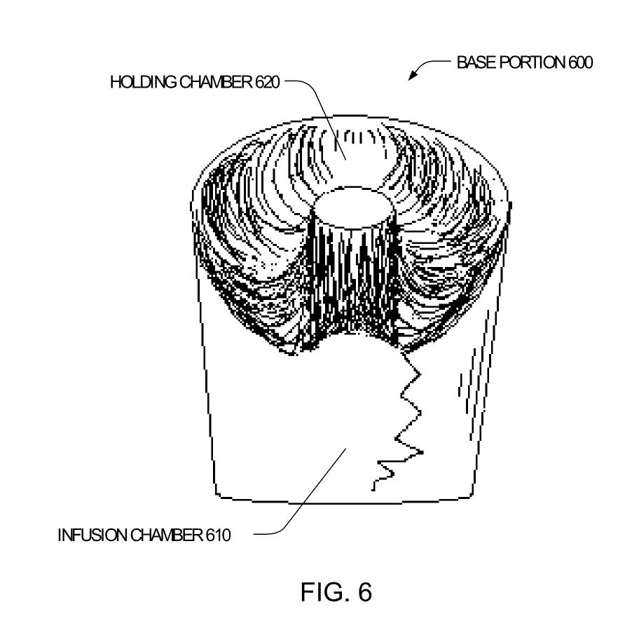

The configuration of holding chamber 220 can vary in any suitable manner, as illustrated in the embodiments of FIGS. 4-7. FIGS. 4-7 depict base portions comprising infusion chambers and holding chambers that generally correspond to those depicted in FIG. 2. For example, base portion 400 of FIG. 4 has a holding chamber, holding chamber 420, with a substantially conical shape. Base portion 500 of FIG. 5 has multiple holding chambers, holding chamber 520 and holding chamber 530, that are peripherally located in base portion 500. This configuration allows the container to hold more solid food pieces than containers with a single holding chamber. To accommodate even greater portions of solid food pieces, base portion 600 of FIG. 6 has a holding chamber, holding chamber 620, that extends around a perimeter of the attached lid portion (not shown). Holding chamber 620 has a substantially toroidal shape, but can take any other suitable shape that extends around the perimeter of the attached lid portion in other embodiments.

Note that holding chamber 620, as well as the holding chambers of the other illustrated embodiments, are configured such that a channel between an attached lid portion and the bottom of the base portion is preserved. The depth and width of the holding chambers in these embodiments can vary to accommodate a desired portion of solid food pieces, but the placement of the holding chambers can be restricted to avoid penetration by an inlet needle of a brewing machine. Further, the shape of the holding chambers is not limited to those illustrated herein, but can be any suitable shape in accordance with the teachings of the present disclosure. Examples of holding chamber shapes can include, but are not limited to, cylindrical, conical, toroidal, frustum, semispherical and cuboidal.

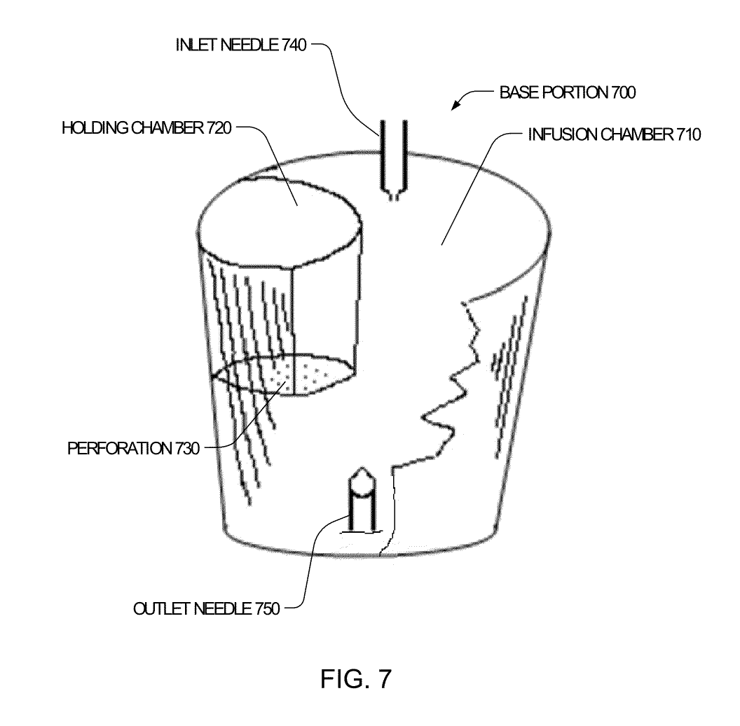

In the embodiment shown in FIG. 7, base portion 700 has a perforated material separating holding chamber 720 from infusion chamber 710. The perforated material defines the bottom of holding chamber 720 in the illustrated embodiment, but can be located at any other suitable location in other embodiments, such as the side of holding chamber 720 or any similar or otherwise suitable location of the holding chambers of any of the other disclosed embodiments. The perforations can allow for heating of the solid food pieces during brewing by the heated liquid injected into infusion chamber 710. For example, the solid food pieces can be heated by steam coming off the injected heated liquid or by the injected heated liquid itself as the liquid level rises in infusion chamber 710 during brewing. The perforations can also be configured small enough to prevent the solid food pieces from exiting into infusion chamber 710.

FIG. 7 further depicts the penetration into infusion chamber 710 of inlet needle 740 and outlet needle 750 of a brewing machine. Note that the present disclosure is not limited to inlet and outlet needles of only brewing machines to provide the functionality described herein. Rather, any type of machine that is configured to penetrate a container with an inlet needle and outlet needle, inject a liquid into the container through the inlet needle, and drain liquid from the container through the outlet needle can be utilized in accordance with the teachings of the present disclosure.

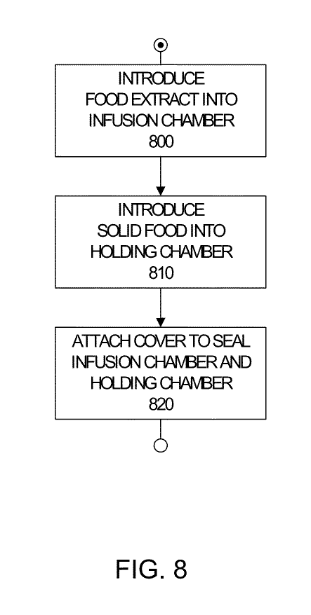

FIG. 8 illustrates an example of how the container can be assembled. In the embodiment illustrated in FIG. 8, a water soluble food extract can be introduced (block 800) into the infusion chamber of the container. One or more solid food pieces can be introduced (block 810) into the one or more holding chambers of the container. The solid food pieces and food extract can be introduced into the base portion of the container in any suitable order or concurrently. After the solid food pieces and food extract have been introduced, the container can be sealed (block 820) with the peelable lid portion. In one embodiment, the top opening of the one or more holding chambers is sealed by the peelable lid portion. In another embodiment, the top opening of the one or more holding chambers is not sealed by the peelable lid portion but is disposed in close enough proximity to the peelable lid portion to prevent the solid food pieces contained therein from exiting into infusion chamber 210 due to handling of the container. The aforementioned steps can be performed solely by one or more pieces of equipment or solely by one or more persons, or by any suitable combination of equipment and persons.

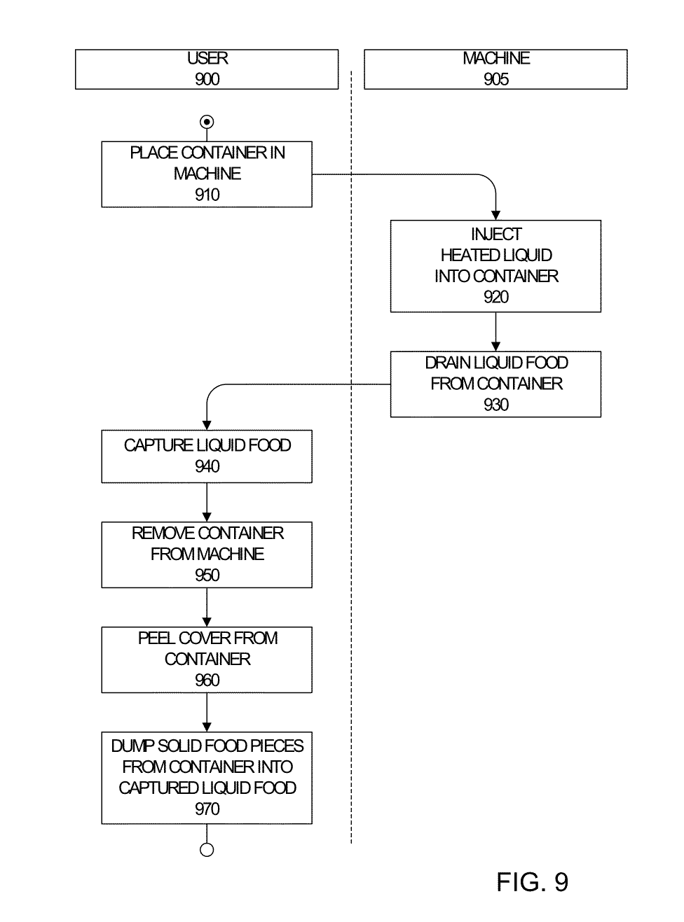

FIG. 9 illustrates an example of how the container can be employed with a brewing machine. In the embodiment illustrated in FIG. 9, user 900 can place (block 910) the container inside brewing machine 905 and activate a brew button associated with brewing machine 905. In response to the brew button being activated, brewing machine 905 can inject (block 920) heated liquid, such as water, into the infusion chamber of the container through an inlet needle of brewing machine 905 piercing the peelable lid portion of the container. Brewing machine 905 can subsequently drain (block 930) liquid food, produced when the water soluble food extract in the infusion chamber is infused with the heated liquid, from the container through an outlet needle of brewing machine 905 piercing the bottom of the base portion of the container. User 900 can capture (block 940) the liquid food drained from brewing machine 905, for example, by placing a cup or bowl below the outlet needle. After the liquid food is captured, user 900 can remove (block 950) the container from brewing machine 905, peel back (block 960) the lid portion of the container thereby exposing the solid food pieces in the holding chamber or chambers, and dump (block 970) the solid food pieces from the holding chamber or chambers into the captured liquid food to complete the preparation of the food product.

By separating the solid food pieces in a chamber separate from the chamber through which heated liquid form a brewing machine is injected and from which the resulting liquid food is drained, the container according to embodiments of the present disclosure prevents the solid food pieces from clogging the outlet needle of the brewing machine, which can result in a failed brew, and/or becoming trapped in the container in a soaked state, which can make removal of the food pieces very difficult after brewing.

Additionally, purchasers of brewing machines can expand the use of their brewers to now brew soups and other food products comprising liquid and solid food. The disclosed food product containers are ideal for travel and provide compact, easy-to-use meal solutions for kids, adults, and the elderly. Businesses can stock these containers as convenient and quick meal solutions for employees who need a healthy snack. Healthy, nutritional, and portion controlled meals can be made with the disclosed containers in less than one minute, for example, for a modest price. The ease-of-use is particularly beneficial for kids and the elderly who may have difficulty in preparing more elaborate meals. The disclosed containers are also highly environmentally sound, potentially acting as a replacement for the existing large Styrofoam instant soup cups in the market that lack inner chambers and merely require the addition of hot water to complete preparation of the soup, which is eaten out the instant soup cup.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A method comprising:
introducing one or more solid food pieces into a first chamber of a container for a food product;
introducing a water soluble food extract into a second chamber of the container; and
sealing the container with a peelable cover.

2. The method of claim 1, wherein the first chamber has a top opening that is sealed by the peelable cover.

3. The method of claim 1, wherein the water soluble food extract produces a liquid food when infused with a heated liquid.

4. The method of claim 3, wherein the food product comprises soup, and the liquid food comprises a broth of the soup.

5. A method comprising:
placing a container for a food product into a machine, the container comprising a water soluble food extract and one or more solid food pieces;
capturing liquid food produced by the machine as a result of the machine infusing the water soluble food extract in the container with heated liquid;
removing the container from the machine;
peeling a cover from the container; and
dumping the solid food pieces from the container into the captured liquid food.

6. The method of claim 5, wherein the food product comprises soup, and the liquid food comprises a broth of the soup.

7. The method of claim 5, wherein the container comprises a first chamber and a second chamber, the first chamber containing the solid food pieces and the second chamber containing the water soluble food extract.

8. The method of claim 7, wherein the machine is configured to pierce the cover of the container with an inlet needle to access the second chamber, and pierce a bottom of the container with an outlet needle to access the second chamber.
